(19) United States
(12) Patent Application Publication
(10) Pub. No.: US 2026/0270968 A1
(43) Pub. Date: Sep. 10, 2026

(54) COGNITIVE MOBILE AD-HOC NETWORK

(71) Applicant: RAFAEL ADVANCED DEFENSE SYSTEMS LTD., Haifa (IL)

(72) Inventors: Avadis SHIMON, Haifa (IL); Glam AVIEL, Haifa (IL); Moshe Miki WEISS, Haifa (IL); Yachil DROR, Haifa (IL)

(21) Appl. No.: 19/167,375

(22) PCT Filed: Mar. 17, 2024
(86) PCT No.: PCT/IB2024/052578

§ 371 Date: Sep. 21, 2025

(30) Foreign Application Priority Data
Mar. 21, 2023 (IL) 301541

(51) Int. Cl. H04W 72/0453

(52) U.S. Cl. CPC H04W 72/0453

(57) ABSTRACT

A MANET has a plurality of nodes and operates in the presence of another radio network. Each of the MANET nodes obtains frequency channel information associated with the radio network from detected transmissions of the radio network. Each node of a first subset of the MANET nodes transmits the obtained frequency channel information according to a cooperative signaling scheme. Each node of a second subset of the MANET nodes receives the obtained frequency channel information transmitted from at least some of the nodes of the first subset. For each node of one or more nodes in the second subset, the node forms a channel map based in part on the received obtained frequency channel information and the frequency channel information obtained by the node. In certain embodiments, at least one node of the one or more nodes in the second subset operates its transceiver according to the channel map.

### TECHNICAL FIELD

The present invention relates to mobile communications, and more particularly, to mobile ad-hoc networks (MANETs) that operate in the presence of other radio networks.

### BACKGROUND OF THE INVENTION

Ad-Hoc networks are communications networks that do not rely on any fixed infrastructure to the extent that other communication networks, such as cellular networks and wireless local area networks (WLAN), do. Nodes of an ad-hoc network that are beyond the communication reach of a transmitting network node may be reached through a relay function. A Mobile Ad-Hoc Network (MANET) is an ad-hoc network formed in an arbitrary network topology. The nodes within a MANET are mobile, and thus may move arbitrarily causing the topology of the network to change rapidly. In certain situations, the deployment of one or more MANET nodes may result in the MANET operating in the presence of another radio communication network, such as a subscriber network.

### SUMMARY OF THE INVENTION

The present invention is a communication system/network (MANET), device/apparatus (i.e., node) of a MANET, and a method for communicating (in a MANET) in the presence of a second communication network such as a subscriber radio communication network.

According to the teachings of an embodiment of the present invention, there is provided a method for communicating in a mobile ad-hoc network (MANET) having a plurality of nodes in the presence of a second communication network. The method comprises: obtaining, by each node of the plurality of nodes, frequency channel information associated with the second communication network from detected transmissions of the second communication network; transmitting, by each of one or more nodes of a first subset of the plurality of nodes, the obtained frequency channel information according to a cooperative signaling scheme; receiving, by each of one or more nodes of a second subset of the plurality of nodes, the obtained frequency channel information transmitted from at least some of the nodes of the first subset; and forming, by each of the one or more nodes of the second subset, a frequency channel map based in part on the received obtained frequency channel information and the frequency channel information obtained by the each of the one or more nodes of the second subset.

Optionally, the method further comprises: operating, by each of at least one node of the one or more nodes of the second subset, a transceiver of the node based on the frequency channel map.

Optionally, the operating the transceiver includes broadcasting data on one or more operational frequencies, of one or more frequency channels, indicated by the frequency channel map as being an available operational frequency.

Optionally, while each of the at least one node broadcasts data on the one or more operational frequencies indicated by the frequency channel map as being an available operational frequency, each of the one or more nodes of the first subset remains idle.

Optionally, the broadcasting data is performed using a sparse frequency waveform.

Optionally, the operating the transceiver includes terminating a transmission of data on one or more operational frequencies, of one or more frequency channels, indicated by the frequency channel map as being unavailable operational frequencies.

Optionally, while each of the one or more nodes of the first subset transmits the obtained frequency channel information, each of the one or more nodes of the second subset detects transmissions of the second communication network.

Optionally, for each node of the second subset, forming the frequency channel map includes fusing the received obtained frequency channel information with the frequency channel information obtained by the node of the second subset, and the fusing is performed using a probabilistic approach.

Optionally, for each node of the second subset, the node decides whether or not to use the obtained frequency channel information received from a given node of the first subset to form the frequency channel map based on at least one criterion.

Optionally, for each node of the first subset, the node decides whether or not to transmit the frequency channel information obtained by the node based on at least one criterion.

Optionally, for each node of the first subset, the transmitting the obtained frequency channel information according to a cooperative signaling scheme includes transmitting a waveform that is representative of spectral characteristics of the second communication network.

Optionally, for one or more nodes of the second subset the obtaining frequency channel information associated with the second communication network includes detecting, by each node of the one or more nodes of the second subset, transmissions of the second communication network.

Optionally, for one or more nodes of the first subset the obtaining frequency channel information associated with the second communication network includes detecting, by each node of the one or more nodes of the first subset, transmissions of the second communication network.

Optionally, for one or more nodes of the first subset the obtaining frequency channel information associated with the second communication network includes receiving frequency channel information associated with the second communication network from one or more network sensors, separate from the MANET, that detect transmissions of the second communication network.

There is also provided according to the teachings of an embodiment of the present invention a mobile ad-hoc network (MANET) for communicating in the presence of a second communication network. The MANET comprises: a plurality of nodes, each of the nodes configurable to function according to a first modality in which the node is configured as an operative node and a second modality in which the node is configured as a non-operative node, and for each node: when functioning according to the second modality the node is configured to: i) obtain frequency channel information associated with the second communication network from detected transmissions of the second communication network, and ii) transmit the obtained frequency channel information according to a cooperative signaling scheme, and when functioning according to the first modality the node is configured to: i) obtain frequency channel information associated with the second communication network from detected transmissions of the second communication network, ii) receive the obtained frequency channel information transmitted from at least some of the non-operative nodes, and iii) form a frequency channel map based in part on the received obtained frequency channel information and the frequency channel information obtained by the node.

Optionally, for each node, when functioning according to the first modality, the node is configured to operate a transceiver of the node based on the frequency channel map.

Optionally, for each node, when functioning according to the first modality, the node is configured to operate the transceiver of the node to broadcast data on one or more operational frequencies, of one or more frequency channels, indicated by the frequency channel map as being an available operational frequency channel.

Optionally, the node is configured to broadcast data using a sparse frequency waveform.

Optionally, for each node, when functioning according to the second modality, the node remains idle while any other node that functions according to the first modality broadcasts data on the one or more operational frequencies indicated by the frequency channel map as being an available operational frequency.

Optionally, for each node, when functioning according to the first modality, the node is configured to operate the transceiver of the node to terminate a transmission of data on one or more operational frequencies, of one or more frequency channels, indicated by the frequency channel map as being unavailable operational frequencies.

Optionally, for each node, when functioning according to the first modality, the node is configured to obtain frequency channel information associated with the second communication network by detecting transmissions of the second communication network.

Optionally, for each node, when functioning according to the second modality, the node is configured to obtain frequency channel information associated with the second communication network by detecting transmissions of the second communication network.

Optionally, for each node, when functioning according to the second modality, the node is configured to obtain frequency channel information associated with the second communication network by receiving frequency channel information associated with the second communication network from one or more network sensors, separate from the MANET, that detect transmissions of the second communication network.

There is also provided according to the teachings of an embodiment of the present invention a node that is one of a plurality of such nodes of a mobile ad-hoc network (MANET) for communicating in the presence of a second communication network. The node comprises a transceiver and is configured to: function according to a first modality in which the node is configured as an operative node and a second modality in which the node is configured as a non-operative node, and when functioning according to the second modality the node is configured to: i) obtain frequency channel information associated with the second communication network from detected transmissions of the second communication network, and ii) transmit the obtained frequency channel information according to a cooperative signaling scheme, and when functioning according to the second modality the node is configured to: i) obtain frequency channel information associated with the second communication network from detected transmissions of the second communication network, ii) receive the obtained frequency channel information transmitted from at least some of the non-operative nodes of the MANET, and iii) form a frequency channel map based in part on the received obtained frequency channel information and the frequency channel information obtained by the node.

Optionally, when functioning according to the first modality, the node is configured to operate the transceiver based on the frequency channel map.

Optionally, when functioning according to the first modality, the node is configured to operate the transceiver to broadcast data on one or more operational frequencies, of one or more frequency channels, indicated by the frequency channel map as being an available operational frequency.

Optionally, the transceiver is configured to broadcast the data using a sparse frequency waveform.

Optionally, when functioning according to the second modality, the node remains idle while any other node of the MANET that functions according to the first modality broadcasts data on the one or more operational frequencies indicated by the frequency channel map as being an available operational frequency.

Optionally, when functioning according to the first modality, the node is configured to operate the transceiver to terminate a transmission of data on one or more operational frequencies, of one or more frequency channels, indicated by the frequency channel map as being unavailable operational frequencies.

Optionally, when functioning according to the first modality, the node is configured to obtain frequency channel information associated with the second communication network by detecting transmissions of the second communication network.

Optionally, when functioning according to the second modality, the node is configured to obtain frequency channel information associated with the second communication network by detecting transmissions of the second communication network.

Optionally, when functioning according to the second modality, the node is configured to obtain frequency channel information associated with the second communication network by receiving frequency channel information associated with the second communication network from one or more network sensors, separate from the MANET, that detect transmissions of the second communication network.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1 is a schematic representation of a cognitive mobile ad-hoc network (MANET) that has a plurality of cognitive nodes that are each configurable to function as an operative node and a non-operative node, and that operates in the presence of another radio communication network, according to embodiments of the present invention;

FIG. 2 is a schematic block diagram illustrating some of the components of an exemplary node of the MANET of FIG. 1, including a transceiver formed from a combination of a transmitter and a receiver, and a spectral map formation module that forms a spectral map containing spectral occupancy information that is indicative of the spectral occupancy of the spectral band assigned to another radio communication network, according to embodiments of the present invention;

FIG. 3 is a block diagram of an exemplary transmitter that can be employed by the transceiver of FIG. 2;

FIG. 4 is a block diagram of an exemplary multi-channel receiver that can be employed by the transceiver of FIG. 2;

FIG. 5 is a state diagram illustrating states that can be assumed by the cognitive nodes of the MANET of FIG. 1, and the transitions between the states based on the functioning of the nodes as operative nodes and non-operative nodes when the MANET performs processes to operate in the presence of another radio communication network, according to embodiments of the present invention;

FIG. 6 is a timing diagram corresponding to the state diagram of FIG. 5, showing transmit and receive periods corresponding to the states for an exemplary operative node and an exemplary non-operative node of the MANET, according to embodiments of the present invention;

FIG. 7 is a schematic representation of a MANET that operates in the presence of another radio communication network, according to another embodiment of the present invention; and

FIG. 8 is a flow diagram illustrating a process for communicating in a MANET in the presence of another radio communication network, according to embodiments of the present invention.

### DESCRIPTION OF THE PREFERRED EMBODIMENTS

The present invention is a communication system/network (MANET), device/apparatus (i.e., node) of a MANET, and a method for communicating (in a MANET) in the presence of a second communication network such as a subscriber radio communication network.

The principles and operation of the system, device, and method according to present invention may be better understood with reference to the drawings accompanying the description.

Before explaining at least one embodiment of the invention in detail, it is to be understood that the invention is not necessarily limited in its application to the details of construction and the arrangement of the components and/or methods set forth in the following description and/or illustrated in the drawings and/or the examples. The invention is capable of other embodiments or of being practiced or carried out in various ways.

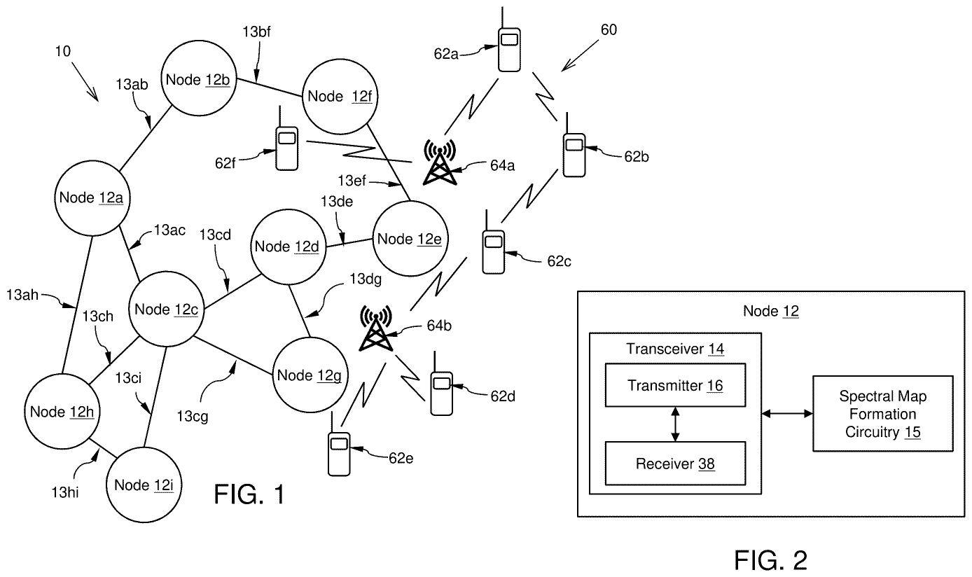

Referring now to the drawings, FIG. 1 illustrates a cognitive MANET, generally designated 10, according to certain embodiments of the present disclosure. Generally speaking, the MANET 10 is formed from a plurality of cognitive nodes, designated 12a through 12i. Each of the nodes 12a through 12i is in direct or indirect signal communication with every other node of the MANET 10 via one or more communication links, designated 13ab, 13ac, 13ah, 13bf, 13cd, 13cg, 13ch, 13ci, 13de, 13dg, 13ef, and 13hi. Although nine nodes are illustrated in FIG. 1 for simplicity of presentation, embodiments of the present disclosure can be implemented in MANETs having any number of nodes, including several tens of nodes, several hundreds of nodes, or more. In addition, the number of nodes that are part of the MANET 10 may change over time as new nodes join the MANET 10 and/or leave the MANET 10.

Parenthetically, the letters used as part of a communication link identifier are indicative of the two nodes that are in direct signal communication with each other over that communication link, i.e., nodes that can communicate with each other without needing a relay. Thus, for example, communication link 13ab is the communication link through which nodes 12a and 12b are in direct signal communication with each other. Preferably, each of the communication links is a bidirectional link that supports signal transmission from the first node connected to a communication link to the second node connected to the communication link, and vice versa. Thus, for example, communication link 13ab preferably supports direct signal transmission from node 12a to node 12b and direct signal transmission from node 12b to node 12a.

Within the context of the present disclosure, a pair of nodes that are in direct communication with each other (i.e., without an intervening relay node) and are within communication reach of each other are referred to interchangeably as “neighboring nodes” or “neighbor nodes”. Thus, for example, the pair of nodes 12a, 12b are neighboring or neighbor nodes, as are, for example, the pair of nodes 12b, 12f. According to this definition of neighboring nodes, the pair of nodes 12a, 12f are not neighboring nodes, since the nodes 12a, 12f are in indirect communication with each other.

Within the context of the present disclosure, a “network hop” refers to the number of communication links (e.g., 13ab, 13bf, etc.), and preferably the smallest number of such links, that are traversed in order for a pair of nodes to communicate with each other. Accordingly, within the context of the present disclosure a pair of neighboring nodes are separated by one network hop, whereas a pair of non-neighboring nodes are necessarily separated by more than one network hop. Thus, for example, the nodes 12a, 12b are separated by one network hop, whereas the nodes 12a, 12f are separated by two network hops. It is noted that although a pair of nodes may be ideally separated by a certain number of network hops along a particular communication route, other routes may be available through the network which may require more network hops, and may become necessary as one or more of nodes moves or one or more nodes leave or join the network, thereby causing the topology of the MANET 10 to change. For example, although initially the node 12a may communicate directly with node 12b (via one network hop), re-deployment or movement of either or both of the nodes 12a, 12b may result in instances or situations in which the nodes 12a, 12b are out of communication reach with each other (i.e., in which the link 13ab is no longer viable or stable), thus resulting in a situation in which the node 12a communicates with the node 12b indirectly, for example via the path of nodes 12a-12c-12d-12b (i.e., three network hops).

The deployment and the topology of the MANET 10 is such that the MANET 10 operates in the presence of a second radio communication network 60 having a plurality of network devices such as terminals, base stations, wireless access points, and the like. In FIG. 1, the network devices of the communication network 60 are represented as terminals 62a through 62f and base stations 64a and 64b. It is noted, however, that the communication network 60 can include any number of network devices. Unlike the MANET 10, the communication network 60 typically has a fixed infrastructure, and may typically be a subscriber network such as a cellular network or wireless area network. The network devices of the communication network 60 are operative to transmit and/or receive signals in a plurality of frequency channels that define the operational RF band that is assigned (allocated) to the communication network 60.

The operation of the MANET 10 in the presence of the communication network 60 may be due to the radio proximity of some of the MANET nodes to some of the network devices of the communication network 60, which can present a potential for one or more nodes of the MANET 10 to interfere with the communications of network devices of the communication network 60. It is noted that the proximity of the MANET nodes to each other and to the network devices of the communication network 60 may change over time due to the changing topology of the MANET as one or more of the MANET nodes moves and/or one or more nodes leave and/or join the MANET. Therefore, the potential for interference with the communications of the network device of the communication network 60 by a MANET node may change over time.

Embodiments of the present invention provide methods which allow the MANET 10 to operate in the presence of the communication network 60, and in particular to allow the MANET 10 to utilize the spectral resources (i.e., some of the frequency channels) that are allocated to the communication network 60, without interfering with the communications of the network devices of the communication network 60. As will be discussed in detail in subsequent sections of the present disclosure, the utilization of the spectral resources is due to the cognitive nature of the nodes of the MANET 10 which allows nodes of the MANET 10 to individually and collectively sense and measure the state of the communication network 60 including the spectral occupancy of the communication network 60, and allows individual MANET nodes to adjust their operation based on current knowledge of the spectral environment. More particularly, the nodes of the MANET 10 according to embodiments of the present disclosure use a cooperative detection and frequency channel information sharing scheme to allow certain MANET nodes to each form a frequency channel map that contains spectral occupancy information that is indicative of the current spectral occupancy of the spectral (RF) band assigned to the communication network 60, and to then adjust their operation based on the frequency channel map.

Before explaining the details of the methods according to embodiments of the present invention in detail, the following paragraphs first provide a general introduction with respect to the functionality of the MANET 10 and its nodes.

According to certain embodiments, the nodes of the MANET 10 employ a combined frequency division multiple access (FDMA) and time division multiple access (TDMA) channel access scheme, referred to herein as frequency-time division multiple access (FTDMA), which allows the nodes to transmit different data streams over different frequency channels at different time-slots. The frequency channels are sub-divisions of an overall operational RF band that is assigned to the MANET 10, and are referred to herein interchangeably as “logical channels”. In other words, the operational band assigned to the MANET 10 is divided into a plurality of logical channels. Each node can transmit at (or “in”) one or more operational frequencies in one or more logical channels in one or more time-slots in accordance with resources allocated from a resource allocation table, as described in commonly owned International Patent Application No. PCT/IB2023/050167, entitled “Resource Management and Routing in Mobile Ad-Hoc Networks That Employ Multi-Channel Reception and Cooperative Relaying”, which is incorporated by reference in its entirety herein.

Each logical channel can, for example, be sub-divided into one or more frequency sub-channels (referred to interchangeably herein as “sub-channels”), where each frequency sub-channel supports transmission at a frequency or frequencies of the one or more frequencies of the logical channel. In other words, each sub-channel can contain one or more operational frequencies at which the node can transmit. As an example, consider a MANET having an assigned operational band of 100-200 MHz, with 1 MHz frequency channels and 100 kHz sub-channels. In such an example, the MANET has a first frequency channel of 100-101 MHz, a second frequency channel of 101-102 MHz, and so on and so forth, up to a hundredth frequency channel of 199-200 MHz. If the sub-channels are 100 kHz sub-channels, the nodes of the MANET can operate at ten 100 kHz sub-channels of each frequency channel, and each operational frequency at which the node can transit is contained in a given one of the sub-channels. So, for example, for the first frequency channel (100-101 MHz channel), the nodes of the MANET may operate at one or more operational frequencies in a first sub-channel of 100-100.1 MHz (for example at 100.05 MHz), one or more operational frequencies in a second sub-channel of 100.1 MHz-100.2 MHz (for example at 100.15 MHz), and so on and so forth, up to one or more operational frequencies in a tenth sub-channel 100.9-101 MHz (for example at 100.95 MHz), and for the second frequency channel (101-102 MHz channel), the nodes of the MANET may operate at one or more operational frequencies in a first sub-channel of 101-101.1 MHz (for example 101.05 MHz), one or more operational frequencies in a second sub-channel of 101.1 MHz-101.2 MHz (for example 101.15 MHz), and so on and so forth, up to one or more operational frequencies in a tenth sub-channel 101.9-102 MHz (for example 101.95 MHz), and so on and so forth, up to the hundredth frequency channel (199-200 MHz), for which the nodes of the MANET may operate at one or more operational frequencies in a first sub-channel of 199-199.1 MHz (for example 199.05 MHz), one or more operational frequencies in a second sub-channel of 199.1 MHz 199.2 MHz (for example 199.15 MHz), and so on and so forth, up to one or more operational frequencies in a tenth sub-channel 199.9-200 MHz (for example 199.95 MHz).

With continued reference to FIG. 1, refer also to FIG. 2 which illustrates a schematic block diagram of some of the components of an exemplary node 12 that is part of the MANET 10. Without loss of generality, the node 12 is a representation of each of the nodes 12a through 12i of FIG. 1. In other words, without loss of generality, each of the nodes 12a through 12i can be considered as having components represented in the exemplary block diagram of FIG. 2. Furthermore, any nodes which may join the MANET 10 can each be considered as having components represented in the exemplary block diagram of FIG. 2. The node 12 includes a transceiver 14 that is operative in a plurality of frequency channels that define the operational RF band assigned to the MANET 10, and that is formed from a combination of a transmitter 16 and a receiver 38. It is noted that the operational RF band assigned to the MANET 10 can include some or all of the frequency channels that are assigned to the communication network 60.

In certain embodiments, the node 12 further includes a spectral map formation module 15 that is configured to form the aforementioned frequency channel map from frequency channel information obtained by the node itself and received from other nodes of the MANET 10, as will be described in subsequent sections of the present disclosure.

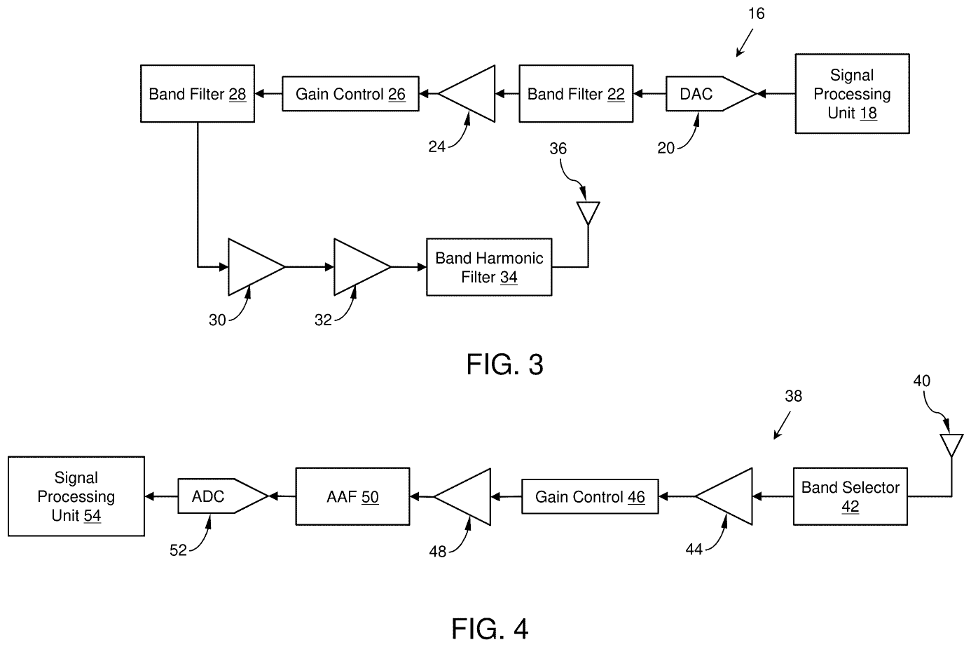

The transmitter 16 is capable of dynamically selecting one or more frequency channels (logical channels), selected from the plurality of frequency channels that define the operational RF band assigned to the MANET 10, and broadcasting (transmitting) signals at one or more operational frequencies (for example in one or more sub-channels) in each of the selected one or more frequency channels to one or more neighbor nodes (next hop nodes). FIG. 3 schematically illustrates an exemplary but non-limiting transmitter 16, which includes a signal processing unit 18, a digital to analog converter (DAC) 20, a pair of band filters 22 and 28, an RF amplifier 24, gain control circuitry 26, RF driver 30, RF power amplifier 32, band harmonic filter 34, and antenna 36.

The signal processing unit 18 is operative to process (e.g., encode and modulate) and/or generate digital signals. The DAC 20 is in signal communication with the signal processing unit 18, and is operative to convert digital signals received from the signal processing unit 18 to analog samples. The band filter 22 is in signal communication with the DAC 20 and is operative to filter the analog samples received from the DAC 20 so complete transformation of the analog samples to analog form. The RF amplifier 24 is in signal communication with the filter 22 and is operative to provide pre-amplification of the signals received from the filter 22. The gain control circuitry 26 is in signal communication with the RF amplifier 24 and is operative to adjust the gain of the pre-amplified signals received from the RF amplifier 24, for example by adjusting the attenuation level applied to the pre-amplified signal. Although not illustrated, the gain control circuitry 26 may be controlled by a control unit (e.g., a digital control unit or an analog control unit) that is linked to, connected to, or otherwise associated with, the signal processing unit 18. The second band filter 28 is in signal communication with the gain control circuitry 26 and is operative to further filter the analog signals received from the gain control circuitry 26 in order to clean up any distortion products introduced by the RF amplifier 24. The RF driver 30 is in signal communication with the band filter 28 and is operative to generate the RF signal to be transmitted, typically by modulating the signal received from the band filter 28 according to the modulation scheme defined by the signal processing unit 18 and amplifying the signal to a level sufficient to drive the RF power amplifier 32. The RF power amplifier 32 is in signal communication with the RF driver 30 and is operative to amplify the typically lower power waveform signal that is generated by the RF driver 30. The band harmonic filter 34 is in signal communication with the RF power amplifier 32 and is operative to apply harmonic filtering to the amplified signal received from the RF power amplifier 32 in order to reduce harmonic distortion effects resultant from power amplifier products at multiples of the transmit frequency (frequency channel). The antenna 36 (which may include one or more antenna elements) is in signal communication with the band harmonic filter 34 and is operative to emit waves of electromagnetic radiation in frequency channels (designated by the band filters 22 and 28) corresponding to the signal received from band harmonic filter 34.

The receiver 38 is a wideband receiver that is capable of simultaneously receiving and processing signals received from other nodes of the MANET 10 in a plurality of different frequency channels (logical channels) selected from the plurality of frequency channels that define the entire operational RF band assigned to the MANET 10. In other words, the receiving frequency channels are among the plurality of frequency channels from which the transmitter 16 selects to transmit (i.e., the transmitter 16 and receiver 38 both operate on frequencies that are selected from the same plurality of frequency channels). The receiver 38 is thus referred to as a “multi-channel receiver”, thereby characterizing the MANET 10 as having “multi-channel reception” or “MCR” capability. FIG. 4 schematically illustrates an exemplary multi-channel receiver 38, which includes an antenna 40, band preselector 42, low-noise amplifier (LNA) 44, gain control circuitry 46, ADC driver 48, anti-aliasing filter (AAF) 50, analog to digital converter (ADC) 52, and signal processing unit 54.

The antenna 40 is operable to receive a plurality of radio signals across the entire operational band of the MANET 10, and can include one or more antenna elements. The band preselector 42 is in signal communication with the antenna 38 and is operative to filter the analog signals received from the antenna 40 so as to select a frequency band (preferably a wideband range of frequencies) that includes a plurality of frequency channels. The LNA 44 is in signal communication with the band preselector 42, and is configured to increase the signal strength of the signals in the selected frequency band and to prevent noise in subsequent stages from contributing materially to signal sensitivity. The gain control circuitry 46 is in signal communication with the LNA 44 and provides gain control functionality, typically in the form of automatic gain control (AGC) functionality, by amplifying and/or attenuating, as necessary, the received signals from the LNA 44. The ADC driver 48 is in signal communication with the gain control circuitry 46 and is operative to operate on the signals received from the gain control circuitry 46 by performing one or more of amplitude scaling, buffering, offset adjustment, and filtering. The AAF 50 is in signal communication with the ADC driver 48 and is operative to pass frequencies that are below the Nyquist bandwidth associated with the sampling rate of the ADC 52 and reject frequencies above the Nyquist bandwidth. The AAF 50 can be implemented as a low-pass filter having the associated Nyquist frequency as the filter cutoff frequency, or in cases where the ADC 52 may perform undersampling or downsampling the AAF 50 may be implemented as a band-pass filter. The ADC 52 is in signal communication with the AAF 50 and is operative to convert the signals from the AAF 50 to digital signals, i.e., to digitize the signals from the AAF 50. Preferably, the ADC 52 is a high-speed high-dynamic-range ADC, such as those used in direct RF sampling receivers that can be, for example, implemented as software defined radio receivers. Most direct RF sampling ADCs achieve a high clock rate using interleaving techniques. The signal processing unit 54 is in signal communication with the ADC 52 and is operative to simultaneously process the digital signals from the ADC 52, i.e., simultaneously process the signals in all of the selected frequency channels. The signal processing unit 54 may include a digital filter bank for dividing the frequency band to the selected frequency channels and a modem for demodulating, decoding, and generating digitized baseband signals at each of the selected frequency channels according to the modulation and coding scheme employed by the corresponding transmitter. The signal processing unit 54 may further employ one or more processors, for example in the form of one or more digital signal processors (DSPs), for processing the digitized baseband signals to recover desired signals in each of the selected frequency channels.

Further details of transceiver architectures that provide multi-channel reception (MCR) capability for a MANET are described in commonly owned U.S. Pat. No. 9,438,386, which is incorporated by reference in its entirety herein.

The nodes of the MANET 10 operate in a half-duplex (HDX) regime, meaning that during a given time-slot a node can either transmit or receive, but not both. In other words, a node cannot simultaneously transmit signals and receive signals, i.e., each node cannot receive during transmission and cannot transmit during reception. However, due to the MCR capabilities of the MANET nodes, each node is capable of receiving signals simultaneously at a plurality of frequency channels from one or more other nodes of the MANET.

Parenthetically, one of the main challenges in MANETs is maximizing user (node) throughput for a certain allocated bandwidth. In conventional MANETs, the throughput tends to decrease as the number of nodes increases (resulting in an increase in network hops) due to packet (messages) retransmissions via relay nodes that are necessary to accommodate communication between nodes that are out of direct communication reach of each other. Such throughput challenges are typically resolved by employing routing and media access layer (MAC) algorithms, where the routing algorithm aims to select the minimum number of relays that will cover the network, and the MAC algorithm aims to schedule when each node is allowed to transmit while simultaneously avoiding collisions and utilizing allocated bandwidth efficiently by appropriately allocating the resources of the network to the network nodes. According to preferred embodiments, the MANET 10 employs a cooperative relay scheme in which each relay node can transmit the same packet simultaneously, thereby consuming a relatively small number of transmissions when broadcasting a packet (message) from a source node to a destination node. Further discussion of MANETs that employ MCR together with cooperative relay can be found in the aforementioned PCT/IB2023/050167.

Bearing all of the above in mind, the following paragraphs describe the methods and functions of the MANET nodes by which the MANET can utilize the spectral resources of the communication network 60 without interfering with the communication of the communication network 60, according to embodiments of the present disclosure.

In general, each node of the MANET 10 is configurable to function according to two modalities (i.e., operate in two modes of operation). In one modality (mode of operation), the node functions (operates) as a non-channel-accessing node (also referred to as a non-data-transmitting node) in which the node is not configured to access any allocated frequency channels (logical channels) to transmit or broadcast operative information to other nodes of the MANET 10. A node can, however, transmit or broadcast frequency channel information associated with the communication network 60 when operating as a non-channel-accessing node. In the other modality (mode of operation), the node functions (operates) as a channel-accessing node (also referred to as a data-transmitting node) in which the node is configured to access one or more allocated frequency channels to transmit or broadcast operative information on one or more operational frequencies (for example in one or more sub-channels) in (or “of”) those one or more allocated frequency channels to other nodes of the MANET 10. This “operative information” is in the form of data communication packets/messages that are wirelessly communicated between the nodes of the MANET 10 (by employing modulation and encoding by the transmitter 16) using allocated frequency channels that are assigned according to MAC algorithms whose role it is to coordinate between the nodes on how to use the communication medium (channel) to avoid collisions. The “operative information” (i.e., data communication packets/messages) does not include signals or messages relating to frequency channel information associated with the communication network 60. A channel-accessing node is also interchangeably referred to herein as an “operative node”, and a non-channel-accessing node is also interchangeably referred to herein as a “non-operative node”.

It is noted that each node of the MANET 10 can switch between the two modalities such that the configuration of the nodes of the MANET 10 may (and typically does) change dynamically over time. As a result, during one data transmission period one group of nodes can be configured to function as operative nodes (i.e., channel-accessing nodes) and a corresponding group of nodes can be configured to function as non-operative nodes (i.e., non-channel-accessing nodes), whereas in another data transmission period a different group of nodes can be configured to function as operative nodes and a different corresponding group of nodes can be configured to function as non-operative nodes. Thus, at any given time the nodes of the MANET 10 are sub-divided into two separate (non-overlapping) groups (also referred to as subsets), namely one group of operative nodes, and another group of non-operative nodes.

The configuration of the MANET nodes as operative nodes and as non-operative nodes at any given time is typically due to the dynamic topology and/or network configuration/parameters of the MANET 10 and/or the dynamic transmission needs/requirements of the nodes to support transmission and relay of session messages. The MANET 10 uses MAC algorithms, and preferably the MAC algorithms disclosed in the aforementioned PCT/IB2023/050167, to manage the topology and/or network configuration/parameters of the MANET 10 as well as the transmission needs/requirements of the nodes and/or the MANET 10 as a whole, including, for example, priority, network load, queues, and the like. Thus, according to embodiments of the present disclosure, at any given time during the operation of the MANET 10, the configuration of the MANET nodes as operative nodes and non-operative nodes is based on MAC algorithms (and preferably the MAC algorithms disclosed in the aforementioned PCT/IB2023/050167).

According to embodiments of the present disclosure, the nodes of the MANET 10 perform a multi-stage process in order to allow the MANET 10 to utilize the spectral resources of the communication network 60 without interfering with the communication of the communication network 60. As will become apparent, the functions performed by each node at each stage of the process may be dependent upon the group to which the node belongs (i.e., the type of node, i.e., whether the node is functioning as an operative node or functioning as a non-operative node). The multi-stage process is collaborative/cooperative in nature, whereby information gleaned by some of the MANET nodes (in particular the non-operative nodes) with respect to the spectral occupancy of the communication network 60 is shared with other nodes of the MANET 10 (in particular the operative nodes) so as to inform the decisions of those other nodes with respect the spectral occupancy.

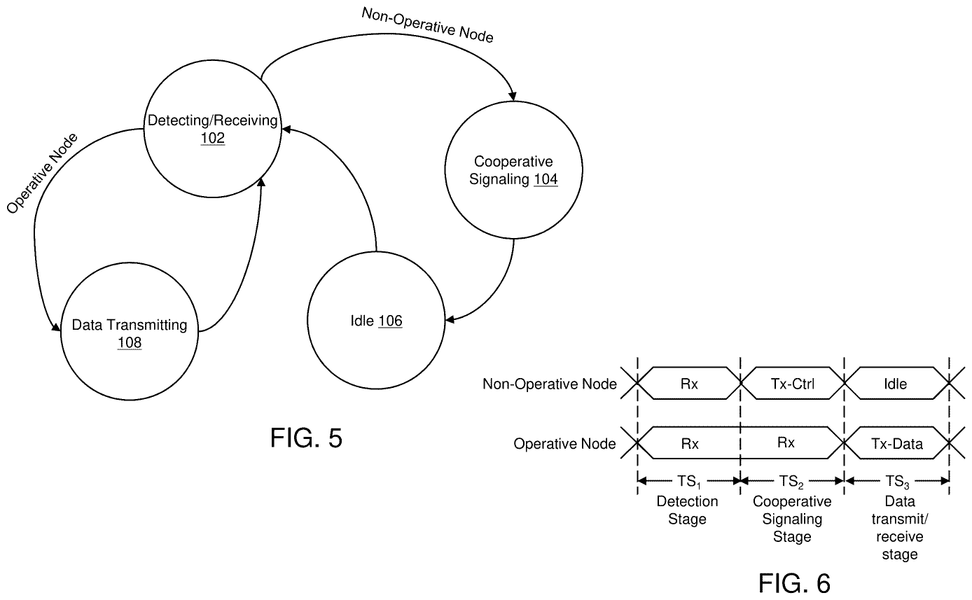

In general, the multi-stage process can be broken into three stages that includes a first stage which is a detection stage, a second stage which is a cooperative signaling stage, and third stage which is a data transmit/receive stage. FIGS. 5 and 6 illustrate a state diagram and a corresponding timing diagram, respectively, which help to illustrate the functions performed by the MANET nodes during the various stages of the multi-stage process. The state diagram and timing diagram of FIGS. 5 and 6 are representative of the functions performed by each node of the MANET 10 when the node functions as an operative node and when the node functions as a non-operative node.

Generally speaking, during the detection stage, represented by the detecting/receiving state 102 in FIG. 5, the nodes (preferably most or all of the nodes of the MANET 10) each perform local detection by detecting transmissions of the communication network 60 to obtain frequency channel information associated with the communication network 60. The local detection is performed by the nodes of both groups. In other words, during the detection stage, both the operative nodes and the non-operative nodes detect the aforementioned communication network 60 transmissions to obtain frequency channel information associated with the communication network 60.

The timing of the detection stage for exemplary operative and non-operative nodes is illustrated in the timing diagram of FIG. 6. As shown in FIG. 6, the detection stage performed during a first time slot, TS₁, in which the nodes (both operative nodes and non-operative nodes) perform local detection (designated by the timing segment labeled “Rx”).

This detection process, also referred to as sniffing, can be performed by each node receiver 38, or, alternatively, can be performed by a dedicated sniffer receiver that is part of each node transceiver 14 or that is in signal communication with the node transceiver 14. Preferably, the receiver 38 or sniffer receiver can be tuned to cover multiple frequency channels such that the node can detect transmissions at multiple frequency channels (and for example the sub-channels thereof).

The processing hardware and/or software of the receiver 38 or sniffer receiver can employ any suitable detection scheme to perform the detection. In one non-limiting example, the signal processing unit 54 can apply rate conversion and windowing to the digitized signals received from the ADC 52 in combination with frequency domain analysis, for example Fast Fourier Transform (FFT), to convert the digitized signals to the frequency domain. The FFT output may then be squared and averaged to produce a spectral metric, and a threshold test can then be applied by comparing the spectral metric to a threshold. The output of the threshold comparison provides an indication of whether or not the node believes that a transmission was made by the communication network 50 at one or more operational frequencies (for example in one or more sub-channels) of one or more frequency channels, and thus provides an indication of whether or not that node believes that any operational frequencies (or sub-channels) of any those one or more frequency channels are available. For example, the node may determine that such a transmission occurred if the metric is greater than or equal to the threshold, and may determine that no such transmissions occurred if the metric is less than the threshold.

Parenthetically, as is well-known in the art of signal processing and detection theory, the value of the threshold can affect the probability of detection (PD) and probability of false alarm (PFA). In general, the PD value is indicative of the likelihood that an operative node will interfere with one or more network devices of the communication network 60 if the operative node transmits at an operational frequency (for example in a sub-channel) of a frequency channel that contributed to the detection output, and the PFA value is indicative of the utilization capacity of the communication network 60. Since it is more critical for the MANET nodes to avoid interfering with the communication network 60, each MANET node should prioritize PD over PFA.

This determination of transmission or lack of transmission at operational frequencies in one or more frequency channels is the frequency channel information that is obtained by the node, which can be propagated or disseminated through the MANET 10 by some or all of the non-operative nodes during the cooperative signaling stage. The frequency channel information obtained by each non-operative node is also referred to as a “local frequency channel map” or “spectral information”, which is a form of control data, and contains spectral occupancy information in the form of an indication of the availability and/or unavailability of operational frequencies in frequency channels that are assigned to the communication network 60. In certain preferred embodiments, the local frequency channel map can be cooperatively signaled by the non-operative nodes using a cooperative relay scheme as discussed above.

It is noted that the frequency channel information obtained by each non-operative node has associated with it a PD value and PFA value, which can be representative of the confidence that the non-operative node has in the frequency channel information. In other words, the associated PD and PFA values may represent the non-operative node's confidence in its indication of transmission or lack of transmission at operational frequencies (for example in one or more sub-channels) of each of the one or more frequency channels.

During the cooperative signaling stage, each of the non-operative nodes transmits (for example by broadcasting) the frequency channel information obtained during the detection stage (as represented by the cooperative signaling state 104 in FIG. 5). The transmitting is performed according to a cooperative signaling scheme such that at least some of the non-operative nodes transmit the frequency channel information simultaneously, and such that the frequency channel information that is to be obtained by the non-operative nodes is disseminated/propagated throughout the MANET 10, for example using the cooperative relay scheme.

According to one non-limiting example embodiment, each of the non-operative nodes disseminates its obtained frequency channel information by transmitting a waveform that represents the spectral absence or presence of transmissions in the communication network 60 at a given frequency channel. In such an embodiment, the spectral occupancy information gleaned (detected) by a given non-operative node is encoded in the waveform that is transmitted/broadcast by the non-operative node, such that waveforms that are cooperatively signaled by the non-operative nodes are together representative of the spectral characteristics of the communication network 60 (in particular the spectral occupancy of the communication network 60). For example, the carrier frequency at which a particular waveform is transmitted by a non-operative node may be in a frequency sub-channel of the communication network 60 that is determined by the non-operative node to be an available frequency sub-channel. In such an example, if an operative node receives such a waveform from a non-operative node, the operative node treats the reception of the waveform as an indication by the non-operative node that the operational frequency of the logical channel is available and/or that the sub-channel that contains the operational frequency is available.

While the non-operative nodes transmit (e.g., broadcast) the aforementioned frequency channel information during the cooperative signaling stage, each of the operative nodes remains in a detection/receive state and continues to detect transmissions of the communication network 60 to obtain frequency channel information associated with the communication network 60, and simultaneously receives the frequency channel information transmitted (cooperatively signaled) from one or more of the non-operative nodes. Each of the operative nodes is able to simultaneously receive the frequency channel information from the non-operative nodes due to the MCR capability of the nodes, which as mentioned above allows each MANET node to receive signals simultaneously at a plurality of frequency channels from one or more other nodes of the MANET 10.

In embodiments in which the cooperative signaling is implemented by each of the non-operative nodes transmitting a waveform that represents the spectral presence of transmissions in the communication network 60, detection of the received frequency channel information by the operative nodes can be achieved using a similar pipeline as used for local detection but adjusted for detecting and receiving the requisite waveforms.

The timing of the cooperative signaling stage for exemplary operative and non-operative nodes is illustrated in the timing diagram of FIG. 6. As shown in FIG. 6, the cooperative signaling stage is performed during a second time slot, TS₂, that begins after the conclusion of TS₁, in which the operative nodes are in a receive state during TS₂ (designated by the timing segment labeled “Rx”) as they continue to detect transmissions of the communication network 60 to obtain frequency channel information and receive the frequency channel information cooperatively signaled by the non-operative nodes, and in which the non-operative nodes are in the cooperative signaling state (designated by the timing segment labeled “Tx-Ctrl”) as they transmit (cooperatively signal) their obtained frequency channel information to other nodes of the MANET 10.

During, or by the conclusion of, the cooperative signaling stage, each of the operative nodes forms a frequency channel map based on its own frequency channel information (obtained during the detection stage and/or during the cooperative signaling stage, i.e., during TS₁ and/or TS₂) and the frequency channel information received from the non-operative nodes (obtained during TS₂). The frequency channel map is formed (i.e., constructed, built, acquired) by a processing module of the operative node, for example the spectral map formation module 15, which processes the frequency channel information (obtained by the node during the detection stage and/or during the cooperative signaling stage) together with the frequency channel information received from the non-operative nodes. The frequency channel map (also referred to as a “spectral map”) that is produced/formed by the aforementioned processing contains up-to-date spectral occupancy information (data) that is indicative of the spectral occupancy of the RF band assigned to the communication network 60. In other words, the spectral map provides the operative node with an up-to-date indication of which operational frequencies of logical channels are in use by the communication network 60 and which operational frequencies of logical channels are not in use by the communication network 60, and for example can provide the operative node with an up-to-date indication of which sub-channels (containing usable operational frequencies) are available (i.e., not in use by the communication network 60) at a given time and which sub-channels (containing non-usable operational frequencies) are unavailable (i.e., in use by the communication network 60) at that given time. Note that in situations in which all of the operational frequencies of a sub-channel of a frequency channel are indicated as being available or unavailable, then that entire frequency sub-channel is indicated as being available or unavailable. Furthermore, in situations in which all of the operational frequencies or all of the sub-channels of a frequency channel are indicated as being available or unavailable, then that entire frequency channel is indicated as being available or unavailable.

Consider again the example of a MANET having an assigned operational band of 100-200 MHz, with 1 MHz frequency channels. Thus, at a given instance, the spectral map formed by a given operative node may indicate that the operational frequencies of 100.25 MHz, 100.35 MHz, 100.45 MHz, 149.05 MHz, 149.15 MHz, 149.25 MHz, 149.35 MHz, 149.45 MHz, and 149.85 MHz are available, and thus the data in the spectral map formed by the operative node may indicate that in the first frequency channel (i.e., 100-101 MHz) the sub-channels covering 100.2-100.5 MHz are available, and in the fiftieth frequency channel (149-150 MHz) the sub-channels covering 149-149.5 MHz and 149.8-149.9 MHz are available, and that all other sub-channels are unavailable.

In certain embodiments, the operative nodes can build-up the data in the spectral map over the duration of the detection stage and cooperative signaling stage, updating the spectral map as new (e.g., more up-to-date) frequency channel information is obtained by the node.

The spectral map formation module 15 may be implemented as suitably configured hardware, including but not limited to, one or more application-specific integrated circuit (ASIC), one or more field-programmable gate array (FPGA), one or more field-programmable logic array (FPLA), or by any suitable combination of hardware/software/firmware. The spectral map formation module 15 may include or may be in data communication with (i.e., communicatively coupled to) one or more data storage devices (e.g., computerized storage/medium) for storing data and/or information that can be used to execute the algorithms for forming the spectral map disclosed herein.

It is noted that in certain embodiments, the spectral map formation module 15 can be part of one of the processing units of the transceiver 14, for example the processing unit 54 of the receiver 38. Alternatively, in embodiments in which local detection is performed by a sniffer receiver that is separate from the receiver 38, the spectral map formation module 15 may be part of a processing unit of the sniffer receiver. In other embodiments, the processing functions that are performed by the spectral map formation module 15 can be performed by one or more of the aforementioned processing units. For example, embodiments are contemplated in which the processing unit 54 performs all reception and detection processing, including processing of received operative information (e.g., demodulation and decoding), processing of received communication network 60 transmissions to locally detect frequency channel information associated with the communication network 60, processing of frequency channel information that is received from the non-operative nodes (via cooperatively signaling), and processing of all of the aforementioned frequency channel information to form the spectral map.

Following the cooperative signaling stage, at least one (and in certain cases each) operative node operates its transceiver 14 based on (i.e., in accordance with) the frequency channel map formed by the operative node. In many cases, this includes operating the transceiver 14 to broadcast operative information at or on one or more operational frequencies of one or more frequency channels(that may be contained in one or more sub-channels) that are indicated as being available operational frequencies and/or available frequency sub-channels by the frequency channel map (i.e., operational frequencies and/or frequency sub-channels that are indicated by the frequency channel map as not in use by the communication network 60 during that time slot). In certain cases, operating the transceiver 14 additionally and/or alternatively includes terminating certain ongoing transmissions at particular operational frequencies (and/or at particular sub-channels). For example, there may be ongoing transmissions of operative information by an operative node using one or more operational frequencies (at, for example, corresponding frequency sub-channels) that are indicated as being unavailable operational frequencies (or unavailable frequency sub-channels) by the frequency channel map (i.e., operational frequencies, or, for example, frequency sub-channels, that are indicated by the frequency channel map as being in use by the communication network 60 during that time slot). In such cases, such an operative node would terminate transmissions on operational frequencies (or corresponding frequency sub-channels) that are indicated as being unavailable operational frequencies or frequency sub-channels (by the frequency channel map) so as to refrain from interfering with the communication transmissions/receptions of one or more network devices of the communication network 60. In certain cases, the transceiver 14 may terminate an ongoing transmission at particular operational frequencies or sub-channels by switching the transmission to one or more operational frequencies or sub-channels that are available operational frequencies or sub-channels.

The broadcasting of the operative information by the operative nodes is performed as part of the data transmit/receive stage. During this stage, the operative nodes are in a data transmitting state 108 (FIG. 5), whereby the operative nodes broadcast operative information (i.e., data communication packets/messages) that is to be received by other nodes of the MANET 10, in particular one or more of the non-operative nodes. Simultaneously, during the data transmit/receive stage the non-operative nodes remain idle, represented by the idle state 106 in FIG. 5, whereby the transceiver of the non-operative nodes is open to receive the operative information (i.e., data communication packets/messages) that is broadcast by the operative nodes.

It is noted that some of the non-operative nodes that receive the broadcast operative information may perform relay function during a next time slot or hop (or operational cycle of the MANET) and thus may function as operative nodes during the next time slot.

The timing of the data transmit/receive stage for exemplary operative and non-operative nodes is illustrated in the timing diagram of FIG. 6. As shown in FIG. 6, the data transmit/receive stage is performed during a third time slot, TS₃, that begins after the conclusion of TS₂, in which the operative nodes are in the data transmission state during TS₃ (designated by the timing segment labeled “Tx-Data”), and in which the non-operative nodes are in the idle state (designated by the timing segment labeled “Idle”). The time slot TS₃ may be one of multiple time slots that are part of a total transmission interval (or hop) during which all of the operative nodes transmit/broadcast their operative information (in accordance with MAC algorithms, in particular the MAC algorithms disclosed in the aforementioned PCT/IB2023/050167). In addition, multiple operative nodes may broadcast operative information during the same time slot TS₃ but using different logical channels (in accordance with a multiple access scheme managed by the MAC algorithms) and/or different sub-channels of the same logical channel.

Parenthetically, it is noted that the timing diagram of FIG. 6 shows only a single cycle of operation for exemplary operative and non-operative nodes of the MANET 10. More particularly, the timing diagram of FIG. 6 shows the timing associated with a single hop (represented by the Tx-Data segment) that may be part of a single session. At the conclusion of the data transmit/receive stage, both operative and non-operative nodes may return to the detecting/receiving state 102 for operation of the next cycle (next hop of the same session, or a hop of a next session), bearing in mind that the configuration of the nodes may change for the next cycle. Accordingly, a given node that functions as an operative node during the present cycle may function as a non-operative node during the next cycle, and a given node that functions as a non-operative node during the present cycle may function as an operative node during the next cycle, depending on the session plan (as managed by the MAC algorithm). In addition, it is further noted that the durations (i.e., lengths) of the different time slots TS₁, TS₂, and TS₃ as shown in FIG. 6 are strictly for example purposes in order to help illustrate the functions performed by the MANET nodes during the various stages of the multi-stage process, and are not necessarily shown to scale. Moreover, the specific durations of the time slots TS₁ and TS₂ may change from cycle to cycle in accordance with the dynamically changing topology and/or network configuration/parameters of the MANET 10.

It is also noted that FIG. 6 illustrates operation timing from a high-level for an exemplary operative node and an exemplary non-operative node during a single operational cycle. In practice, there may be additional shorter duration slots between some of the time slots such that the time slots TS₁, TS₂, and TS₃ as illustrated in FIG. 6 may not necessarily form a continuous time period for an operational cycle. For example, shorter duration slots between the time slots illustrated in FIG. 6 may be used for detection processing, as well as data transmission for operative nodes from previous cycles. For example, there may be a first processing time slot between the end of the detection time slot TS₁ and the beginning of the cooperative signaling time slot TS₂. During this first processing time slot, at least some of the non-operative nodes and at least some of the operative nodes can process the locally detected transmissions of the communication network 60 in order to extract frequency channel information from the detections. In addition, for example, there may be a second processing time slot between the end of the cooperative signaling time slot TS₂ and the beginning of the data transmission time slot TS₃. During this second processing time slot, some of the operative nodes can process the frequency channel information received (i.e., detected) from the non-operative nodes (i.e., the frequency channel information that is cooperatively signaled by the non-operative nodes) together with their own frequency channel information to form frequency channel maps. In addition, during the detection time slot TS₁ of the next operational cycle after the time slot TS₃ of the present operational cycle, some of the non-operative nodes that began transmission during the data transmission time slot TS₃ of the present operational cycle may continue to transmit (broadcast) and forego detection during the detection time slot TS₁ and the cooperative signaling time slot TS₂ of the next operational cycle (and therefore also forego processing during the processing slot after the detection time slot) since those non-operative nodes may already have up-to-date knowledge of the spectral occupancy of the communication network 60. In certain cases, an operative node that already has up-to-date knowledge of the spectral occupancy of the communication network 60 may broadcast operative data immediately after the conclusion of the cooperative signaling time slot TS₂ (i.e., for certain operative nodes that already have up-to-date knowledge of the spectral occupancy, the data transmission time slot TS₃ may begin immediately at the conclusion of the cooperative signaling time slot TS₂.)

As mentioned above, the operative nodes may operate their transceivers 14 to broadcast the operative information on one or more operational frequencies (for example in one or more sub-channels) of one or more frequency channels that are indicated by the frequency channel map as being an available operational frequency (or available sub-channel). Any suitable channel access scheme can be used by the operative nodes of the MANET 10 to broadcast the operative information, including, for example, single carrier multiple access schemes such as single carrier FDMA (SC-FDMA).

It is noted that in addition to the MANET 10 requiring a multiple access scheme to allow multiple MANET nodes to simultaneously transmit on different operational frequencies or sub-channels of a given spectral band (thereby increasing network throughput), the MANET 10 is also preferably configured to keep spectral nulls transmission in available (vacant) frequency sub-channels, i.e., frequency sub-channels containing operational frequencies indicated as being available by the frequency channel map. Accordingly, it is preferable to use a channel access scheme that satisfies both of these criteria. One such suitable channel access scheme is orthogonal frequency division multiple access (OFDMA), where multiple access is achieved by assigning sub-bands (i.e., frequency sub-channels) of sub-carriers to individual operative nodes. It is noted, however, that even when the nodes of the MANET 10 use conventional OFDMA for broadcasting the operative information, the MANET operative nodes may introduce interference to the spectrum allocated to the communication network 60, for example in the form of out-of-band (OOB) emissions. In general, OOB emissions may typically arise as a result of pulse-shaping of the waveform as part of the data transmission process whereby a portion of the radiated power (radiated by the antenna 36 of the node 12) in an available (vacant) frequency sub-channel leaks into one or more neighboring/adjacent sub-bands that are occupied (i.e., in-use) by one or more network devices of the communication network 60. It therefore may, in certain instances, be preferable to utilize a channel access scheme that employs sparse frequency waveforms in order to reduce/mitigate OOB.

The selection of an appropriate channel access scheme to increase network throughput and reduce potential interference with the communication network 60 is one example of potential enhancements that can be made to the MANET 10 and which are contemplated according to embodiments of the present disclosure. In addition to selection of an appropriate channel access scheme, further enhancements are also contemplated herein. One example of further enhancements contemplated according to certain embodiments are enhancements which can be applied with respect to the broadcast of operative information, and in particular at the physical layer and/or the MAC layer, whereby the frame size of operative information messages can be adjusted to suit the dynamically changing frequency channel availability.

Another example of further enhancements contemplated according to certain embodiments are enhancements which can be applied with respect to the cooperative signaling stage and/or the detection stage. As mentioned above, each operative node forms a frequency channel map by processing (for example by the spectral map formation module 15) the frequency channel information (obtained by the operative node during the detection stage and/or during the cooperative signaling stage) together with the frequency channel information received from the non-operative nodes (which are cooperatively signaled during the cooperative signaling stage). In so doing, the frequency channel information obtained by the operative node (via local detection) is fused (combined) with the received frequency channel information. In certain embodiments, the “fusing” (or “combining”) is performed using a probabilistic approach, whereby the PD and PFA associated with the frequency channel information obtained by each non-operative node can be used to inform decisions made by the operative nodes. For example, the PD and PFA associated with the frequency channel information obtained by each non-operative node can be used as a basis of whether or not to use frequency channel information obtained by a given non-operative node. In one example, an operative node that receives frequency channel information from a given non-operative node may choose not to use that frequency channel information in the formation of its spectral map if the Pp value associated with the frequency channel information transmitted by the given non-operative node is below a threshold value (i.e., relatively low, for example less than 70%) and/or if the PFA value associated with the frequency channel information transmitted by the given non-operative node is above a threshold value (i.e., relative high, for example above 50%). The threshold values may be based on various factors, including, for example, system specifications, historical network performance, and the like.

In certain embodiments, the operative nodes may use weighted processing (such as weighted averaging or other statistical combining methods) to fuse the frequency channel information. For example, some of the non-operative nodes may be categorized/classified as “more reliable non-operative nodes”, and the frequency channel information that is received from these “more reliable non-operative nodes” may be provided with higher weights. Similarly, some of the non-operative nodes may be categorized/classified as “less reliable non-operative nodes”, and the frequency channel information that is received from these “less reliable non-operative nodes” may be provided with lower weights. In certain cases, non-operative nodes can be assigned degrees reliability as part of the classification, such that the more reliable a node the higher its associated weight. As an extreme case, the frequency channel information obtained by a non-operative node that is classified as totally or completely unreliable may not be used at all by an operative node in the formation of its spectral map.

The categorization or classification of a given non-operative node as “more reliable” or “less reliable” can be performed by the operative node itself and/or other nodes of the MANET. Moreover, the categorization or classification of non-operative nodes as “more reliable” or “less reliable”, and the selection and assignment of weights to the frequency channel information, can be based on several criteria, including, for example, the type of non-operative node, the location or operating environment of the non-operative node, and the capability and performance of the receiver of the non-operative node. For example, non-operative nodes that are located at higher altitudes may inherently have better detection capabilities than nodes deployed at lower altitudes, as higher altitude nodes may have a more direct line of sight to network devices of the communication network 60, whereas lower altitude nodes may have blockages and obstructions between themselves and the network devices of the communication network 60 and/or may attempt to conceal themselves and/or may be subjected to a large amount of radio interference and noise, for example when deployed in hostile urban environments. Therefore, information received by higher altitude non-operative nodes may be treated with more importance, and thus it may be preferable to assign a higher weight to the frequency channel information that is provided by such high altitude non-operative nodes. Higher altitude nodes can be, for example, nodes that are mounted to aerial platforms, such as unmanned aerial vehicles (UAVs) or smaller-scale drones, as well as hand-held radio nodes operated by personnel located at higher altitudes such as on mountaintops or cliffs overlooking areas in which network devices of the communication network 60 are deployed.

Along the same lines, non-operative nodes having high-performance receivers may inherently be able to provide better detection of transmissions of the communication network 60, and therefore it may be preferable to assign a higher weight to the frequency channel information that is provided by non-operative nodes having such high-performance receivers.

In certain embodiments, the above criteria may also be employed by each non-operative node to decide whether or not to transmit its frequency channel information. For example, non-operative nodes which determine that their own detections of radio transmissions associated with the communication network 60 are unreliable may choose not to cooperatively signal their obtained frequency channel information. As one example, a non-operative node that is deployed in a low-altitude area, such as a hostile urban environment, may classify itself as “less reliable” and therefore choose not to transmit any detected radio transmissions associated with the communication network 60 due, for example, to the increased PFA.

As mentioned above, the receiver 38 or sniffer receiver of each node can be tuned to cover multiple frequency channels such that the node can detect transmissions at multiple frequency channels (and for example the sub-channels thereof). In certain embodiments, the receiver 38 or sniffer receiver of each node can be selectively tuned to cover selected frequency channels and/or selected sub-channels such that the node can detect transmissions at frequencies in the selected frequency channels and/or sub-channels. In certain embodiments, each node may independently select the frequency channels and/or sub-channels to which its receiver 38 or sniffer receiver is tuned, such that the local detection performed by the nodes of the MANET 10 is not uniform across the entire operational RF band assigned to the MANET 10. For example, different nodes of the MANET 10 can be configured to scan different sub-bands or sub-ranges of the operative RF band to locally detect transmissions of the communication network 60 at frequencies in those sub-bands or sub-ranges. For example, a first group of nodes of the MANET may scan a first chunk (slice) of bandwidth (BW) (e.g., a 10 MHz chunk of BW) to locally detect transmissions of the communication network 60 at frequencies in that first chunk, a second group of nodes of the MANET may scan a second chunk of bandwidth (BW) (e.g., another 10 MHz chunk of BW or a chunk of a different BW) to locally detect transmissions of the communication network 60 at frequencies in that second chunk, and so on and so forth. This selective tuning to detect frequencies in selected chunks of BW provides certain processing advantages, in particular reduction in computations, by limiting the spectral window in which frequency domain analysis (e.g., FFT) is performed. For example, FFT processing of smaller chunks of RF bandwidth (e.g., 10 MHz chunks) as compared to FFT processing of the entire RF operational band can significantly reduce computational resources of the processors of the nodes. Preferably, BW parameters (e.g., the size of the chunk of BW and the location (i.e., center frequency) of the chunk within the operational RF band) for each node is configurable from cycle to cycle, such that during a given cycle one or more of the nodes can be configured to detect transmissions of the communication network 60 at different overlapping or non-overlapping frequency chunks.

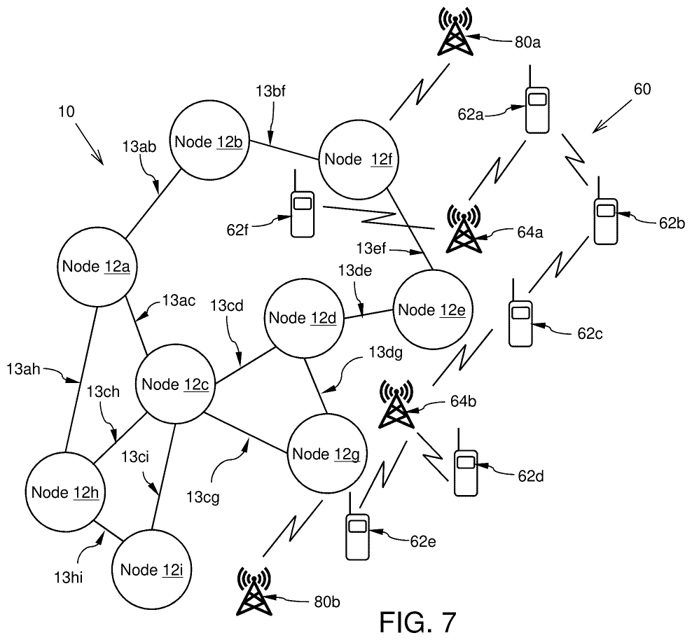

Although the description thus far has pertained to embodiments in which all of the nodes of a MANET perform local detection to obtain frequency channel information, other embodiments are contemplated herein in which at least some of the frequency channel information is provided to at least some of the MANET nodes by one or more network sensor devices (e.g., sniffer receivers) that are separate from the MANET 10 but that are in signal or data communication with some of the nodes, and that are configured to detect transmissions of the communication network 60 (for example using the FFT detection scheme of receiver 38 discussed above) in order to extract frequency channel information. For example, as illustrated in FIG. 7, one or more network sensor devices, represented as sniffer receivers 80a and 80b, can be deployed in radio proximity to the communication network 60 to detect transmissions of the communication network 60 in order to extract frequency channel information which can be provided to at least some of the nodes of the MANET 10. Although only two sniffer receivers 80a, 80b are shown in FIG. 7, any suitable number of sniffer receivers can be employed. The network sensor devices (e.g., sniffer receivers 80a, 80b) that are separate from the MANET 10 are devices that are not a part of the MANET 10, i.e., they are not configured as nodes (neither operative nor non-operative) of the MANET 10 and therefore, in general, do not participate in the broadcasting and/or routing of operative information to nodes of the MANET 10.

In practice, the frequency channel information provided to the nodes by the sniffer receivers 80a, 80b can be provided via signal or data communication, either directly or indirectly. For example, one or more of the sniffer receivers 80a, 80b may directly send the frequency channel information to one or more of the nodes (either non-operative nodes or operative nodes) via RF transmission or a datalink. As another example, one or more of the sniffer receivers 80a, 80b may upload the frequency channel information to one or more servers or databases linked to the MANET 10, and one or more of the nodes (either non-operative nodes or operative nodes) may then “download” the frequency channels information from the servers and/or databases. In operation, it may be more practical to have the non-operative nodes obtain the frequency channel information from the sniffer receivers 80a, 80b. In certain embodiments, all of the non-operative nodes may be configured to receive (either directly or via “download”) the frequency channel information from the detections performed by the sniffer receivers 80a, 80b, and then cooperatively signal the frequency channel information to the operative nodes. In other embodiments, some of the non-operative nodes may be configured to perform their own local detection, whereas other non-operative nodes may be configured to receive the frequency channel information from the detections performed by the sniffer receivers 80a, 80b.

In certain embodiments, different sets of network sensor devices (e.g., sniffer receivers 80a, 80b) can be configured to detect different particular chunks of RF bandwidth, with or without overlap between the different particular chunks. For example, one set of the network sensor devices can be configured to scan frequencies in the high frequency (HF) band (3-30 MHz), another set of the network sensor devices can be configured to scan frequencies in the very high frequency (VHF) band (30-300 MHz), another set of the network sensor devices can be configured to scan frequencies in the ultra high frequency (UHF) band (300 MHz-3 GHz), and so on. As should be apparent, different network devices within a single set can be configured to scan different chunks of a given band. For example, different network devices can be configured to scan different chunks of the HF band, with or without overlap between the chunks of HF band. For example, without overlap, one group of network devices can be configured to scan frequencies in the range of 3-12 MHz, another group of network devices can be configured to scan frequencies in the range of 12-21 MHz, and another group of network devices can be configured to scan frequencies in the range of 21-30 MHz. As another example, with overlap, one group of network devices can be configured to scan frequencies in the range of 3-10 MHz, another group of network devices can be configured to scan frequencies in the range of 8-15 MHz, another group of network devices can be configured to scan frequencies in the range of 13-20 MHz, another group of network devices can be configured to scan frequencies in the range of 18-25 MHz, and another group of network devices can be configured to scan frequencies in the range of 23-30 MHz.

It is noted that during operation of the MANET 10 in the presence of the communication network 60, one or more of the non-operative nodes may glean, from its own local detections or from frequency channel information received from one or more of the sniffer receivers 80a, 80b, that certain frequencies or sub-channels are, or appear to be, indefinitely in use by the communication network 60. Therefore, in certain embodiments, certain frequencies or sub-channels that appear as indefinitely in use by the communication network 60 can be flagged by the one or more non-operative nodes, that obtain the frequency channel information that indicates the indefinite usage, such that the operative nodes, when initially constructing their spectral map, can flag those frequencies or sub-channels as “blocked”, to avoid scanning those frequencies or sub-channels (or chunks of BW carrying those frequencies or sub-channels) during local detection in subsequent operational cycles. During later operational stages, if any of those frequencies or sub-channels become unblocked, one or more of the non-operative nodes can unflag the frequencies or sub-channels such that the relevant operative nodes can update the spectral map to indicate that the unflagged frequencies or sub-channels are “unblocked”. It is noted that the “blocking” for an operative node may be based on one or more characteristics of the node, for example the deployment location of the node. For example, the blocked frequencies or sub-channels (or chunks of BW) for a given operative node may be based on the deployment location of the operative node, such that when the operative node is deployed in one given location a first set of frequencies or sub-channels (or a first chunk of BW) may be blocked, whereas when the operative node is deployed in another given location a second different set of frequencies or sub-channels (or a second chunk of BW, different from the first chunk) may be blocked.

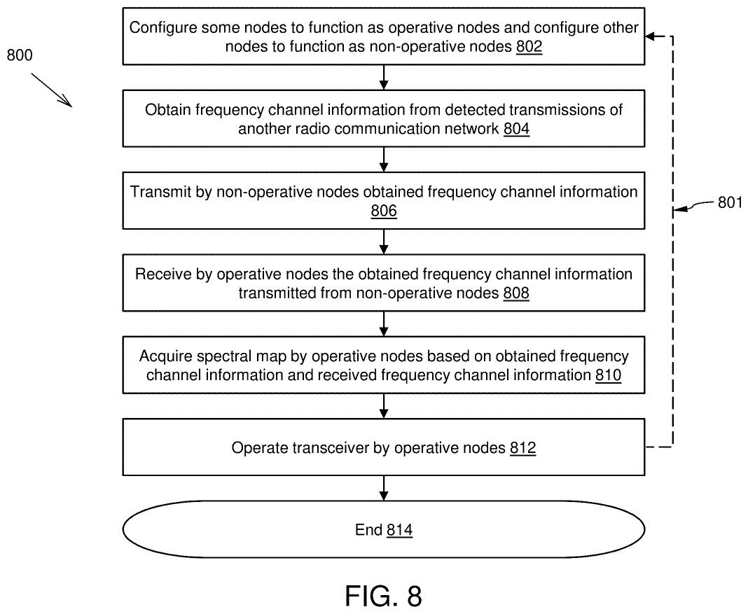

Attention is now directed to FIG. 8, which shows a flow diagram detailing a process 800 in accordance with embodiments of the disclosed subject matter. The process 800 includes algorithm for communicating in a mobile ad-hoc network, such as the MANET 10, in the presence of a second radio communication network (e.g., network 60) and in which each of the nodes of mobile ad-hoc network is provided with a transceiver architecture that provides both multi-channel reception capability and cooperative relay function. Reference is also made to the elements of FIGS. 1-7 . The process and sub-processes of FIG. 8 include computerized (i.e., computer-implemented) processes performed by the various nodes of the network, including, for each node, the transceiver 14 and its associated components, including the transmitter 16 and the receiver 38 (and/or a dedicated sniffer receiver), and the spectral map formation module 15 (or alternatively one or more of the processing units of the transceiver 14) and associated components. The aforementioned process and sub-processes are for example, performed automatically, and are performed, for example, in real time.

The process 800 begins at step 802, which can be considered a node configuration step, whereby some of the nodes of the mobile ad-hoc network are configured to function as operative nodes (i.e., according to one modality) thus forming a group of operative nodes, and other nodes of the mobile ad-hoc network are configured to function as non-operative nodes (i.e., according to another modality) thus forming a group of non-operative nodes. The configuration of the nodes as operative nodes and non-operative nodes (i.e., the modalities of each of the nodes) is for a given operational cycle of the mobile ad-hoc network, for example one network hop. As discussed above, the subdivision of the nodes may change from cycle to cycle, and is based on several factors, including the configuration and topology of the mobile ad-hoc network, the transmission needs or requirements of the nodes and/or the mobile ad-hoc network as a whole, including, for example, priority, network load, and queues (and latency).

At step 804 each of nodes of the mobile ad-hoc network obtains frequency channel information associated with another radio communication network (e.g., network 60) from detected transmissions of the other radio communication network. In certain embodiments, at step 804 the nodes (both the operative nodes and the non-operative nodes) of the mobile ad-hoc network detect transmissions of the other radio communication network. For each node, the receiver 38 of the transceiver 14 (or a separate sniffer receiver) of the node can perform the detection at step 804. In other embodiments, at step 804 at least some of the nodes (for example at least some of the non-operative nodes) receive the frequency channel information from one or more sniffer receivers (e.g., 80a, 80b), that are separate from the mobile ad-hoc network, and that detect transmissions of the other radio communication network.

At step 806, the non-operative nodes transmit (using a cooperative signaling scheme) the frequency channel information obtained at step 804 so as to disseminate (distribute) the frequency channel information throughout the mobile ad-hoc network. In some cases, all of the non-operative nodes transmit their obtained frequency channel information. However, as discussed above, in certain cases some of the non-operative nodes may choose not to transmit their frequency channel information, for example based on a classification of some of the non-operative nodes as “less reliable” nodes which can be based on various criteria, including, for example, poor receiver performance, sub-optimal deployment location (e.g., low altitude), etc. For each non-operative node, the transmitter 16 of the transceiver 14 of the non-operative node can be used to transmit the frequency channel information.

At step 808, at least some (but typically a majority, and in most cases all) of the operative nodes receive the obtained frequency channel information transmitted from at least some of the non-operative nodes (step 806). Each of the “at least some” of the operative nodes simultaneously receives the obtained frequency channel information on one or more logical channels from those “at least some” of the non-operative nodes. Each of these operative nodes can perform this receiving using the receiver 38 of its transceiver 14 (or a separate sniffer receiver). It is noted that while the operative nodes receive the frequency channel information from the non-operative nodes, the operative nodes also continue to detect transmissions of the communication network 60 to obtain frequency channel information associated with the communication network 60 (similar to as performed in step 804, and using the transceiver 14 or a separate sniffer receiver of the nodes).

At step 810, each of the operative nodes that received the obtained frequency channel information from the non-operative nodes at step 808 acquires a spectral map (frequency channel map). Each such operative node acquires its spectral map by processing frequency channel information to form (build-up) the spectral map, in particular by fusing or combining its obtained frequency channel information (as a result of detection performed at step 804 and/or step 808) with the obtained frequency channel information received from the non-operative nodes at step 808. As discussed above the fusing/combining can be performed using weighted processing, whereby the frequency channel information received from “more reliable” non-operative nodes may be assigned a higher weight than the frequency channel information received from “less reliable” non-operative nodes. For each operative node that participates in step 810, the processing (fusing/combining) frequency channel information can be performed by the spectral map formation module 15 of the operative node, or by a processing module of one of the processing units of the transceiver 14 of the operative node, or by a processing module of a sniffer receiver of the operative node.

At step 812, at least one, and in certain cases each, of the operative nodes that formed a spectral map at step 810, operates its transceiver 14 based on (i.e., according to) its acquired spectral map. This operation of the transceiver 14 results in the transceiver 14 executing at least one communication action. In some cases, the communication action executed by the transceiver 14 includes terminating an ongoing transmission of data on (or “at”) particular operational frequencies (and/or particular frequency sub-channels) indicated by the frequency channel map as being unavailable operational frequencies (or frequency sub-channels). In some cases, the communication action executed by the transceiver 14 includes broadcasting data on one or more operational frequencies (or frequency sub-channels) of one or more frequency channels indicated by the spectral map as being an available operational frequency (or frequency sub-channel). As discussed above, while the operative nodes broadcast data on data on available frequency channels (as indicated by the spectral maps), the non-operative nodes remain idle so as to be able to receive the data broadcasts/transmissions from the operative nodes.

If at the conclusion of step 812 the mobile ad-hoc network is still actively operating (i.e., there are still active session messages to be transmitted/broadcast/relayed), the process 800 may return to step 802 from step 812 (denoted by dashed loop-back arrow 801), whereby the nodes of the mobile ad-hoc network are configured (or reconfigured) as operative nodes and non-operative nodes based on, for example, the updated topology of the mobile ad-hoc network. On the other hand, if at the conclusion of step 812 the mobile ad-hoc network is to be torn down or no more session messages are active or need to be transmitted/broadcast/relayed, the process 800 may terminate, as indicated by terminator/end step 814.

In the context of the present disclosure, it is assumed that the nodes of the MANET are provided with time and frequency synchronization in order to enable the nodes to share the frequency channel information with each other and to enable the nodes to effectively communicate with each other. Methodologies for time and frequency synchronization amongst MANET nodes have been developed by Rafael Advanced Defense Systems Ltd. of Israel, and some of these methodologies are described, for example, in commonly owned International Patent Application No. PCT/IB2022/060957, entitled “Frequency Synchronization in Decentralized Communication Networks”, which is incorporated by reference in its entirety herein.

Implementation of the systems and/or methods of embodiments of the disclosure can involve performing or completing selected tasks implemented by hardware, by software or by firmware or by a combination thereof. For example, hardware for performing selected tasks according to embodiments of the disclosure could be implemented as a chip or a circuit. As software, selected tasks according to embodiments of the disclosure could be implemented as a plurality of software instructions being executed by a computer using any suitable operating system. In certain embodiments of the disclosure, one or more tasks according to exemplary embodiments of systems and/or methods as described herein are performed by a computerized data processor that can execute a plurality of instructions. Optionally, the data processor includes a volatile memory for storing instructions and/or data and/or a non-volatile storage, for example, non-transitory storage media such as a magnetic hard-disk and/or removable media, for storing instructions and/or data.

For example, any combination of one or more non-transitory computer readable (storage) medium(s) may be utilized in accordance with the above-listed embodiments of the present disclosure. The non-transitory computer readable (storage) medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

As will be understood with reference to the paragraphs and the referenced drawings, provided above, various embodiments of machine-implemented methods are provided herein, some of which can be performed by various embodiments of systems described herein and some of which can be performed according to instructions stored in non-transitory computer-readable storage media described herein. Still, some embodiments of machine-implemented methods provided herein can be performed by other systems and can be performed according to instructions stored in computer-readable storage media other than that described herein, as will become apparent to those having skill in the art with reference to the embodiments described herein. Any reference to systems and computer-readable storage media with respect to machine-implemented methods is provided for explanatory purposes, and is not intended to limit any of such systems and any of such non-transitory computer-readable storage media with regard to embodiments of computer-implemented methods described above. Likewise, any reference to machine-implemented methods with respect to systems and computer-readable storage media is provided for explanatory purposes, and is not intended to limit any of such computer-implemented methods disclosed herein.

The block diagrams and flowcharts in the drawings illustrate the architecture, functionality, and operation of possible implementations of systems and/or methods according to various embodiments of the present disclosure. In this regard, each block in the block diagrams or flowcharts may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form, “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

To the extent that the appended claims have been drafted without multiple dependencies, this has been done only to accommodate formal requirements in jurisdictions which do not allow such multiple dependencies. It should be noted that all possible combinations of features which would be implied by rendering the claims multiply dependent are explicitly envisaged and should be considered part of the invention.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A method for communicating in a mobile ad-hoc network (MANET) having a plurality of nodes in the presence of a second communication network, the method comprising:
obtaining, by each node of the plurality of nodes, frequency channel information associated with the second communication network from detected transmissions of the second communication network;
transmitting, by each of one or more nodes of a first subset of the plurality of nodes, the obtained frequency channel information according to a cooperative signaling scheme;
receiving, by each of one or more nodes of a second subset of the plurality of nodes, the obtained frequency channel information transmitted from at least some of the nodes of the first subset; and
forming, by each of the one or more nodes of the second subset, a frequency channel map based in part on the received obtained frequency channel information and the frequency channel information obtained by the each of the one or more nodes of the second subset.

2. The method of claim 1, further comprising: operating, by each of at least one node of the one or more nodes of the second subset, a transceiver of the node based on the frequency channel map.

3. The method of claim 2, wherein the operating the transceiver includes broadcasting data on one or more operational frequencies, of one or more frequency channels, indicated by the frequency channel map as being an available operational frequency.

4. The method of claim 3, wherein while each of the at least one node broadcasts data on the one or more operational frequencies indicated by the frequency channel map as being an available operational frequency, each of the one or more nodes of the first subset remains idle.

5. The method of claim 3, wherein the broadcasting data is performed using a sparse frequency waveform.

6. The method of claim 2, wherein the operating the transceiver includes terminating a transmission of data on one or more operational frequencies, of one or more frequency channels, indicated by the frequency channel map as being unavailable operational frequencies.

7. The method of claim 1, wherein while each of the one or more nodes of the first subset transmits the obtained frequency channel information, each of the one or more nodes of the second subset detects transmissions of the second communication network.

8. The method of claim 1, wherein for each node of the second subset, forming the frequency channel map includes fusing the received obtained frequency channel information with the frequency channel information obtained by the node of the second subset, and wherein the fusing is performed using a probabilistic approach.

9. The method of claim 1, wherein for each node of the second subset, the node decides whether or not to use the obtained frequency channel information received from a given node of the first subset to form the frequency channel map based on at least one criterion.

10. The method of claim 1, wherein for each node of the first subset, the node decides whether or not to transmit the frequency channel information obtained by the node based on at least one criterion.

11. The method of claim 1, wherein for each node of the first subset, the transmitting the obtained frequency channel information according to a cooperative signaling scheme includes transmitting a waveform that is representative of spectral characteristics of the second communication network.

12. The method of claim 1, wherein for one or more nodes of the second subset the obtaining frequency channel information associated with the second communication network includes detecting, by each node of the one or more nodes of the second subset, transmissions of the second communication network.

13. The method of claim 1, wherein for one or more nodes of the first subset the obtaining frequency channel information associated with the second communication network includes detecting, by each node of the one or more nodes of the first subset, transmissions of the second communication network.

14. The method of claim 1, wherein for one or more nodes of the first subset the obtaining frequency channel information associated with the second communication network includes receiving frequency channel information associated with the second communication network from one or more network sensors, separate from the MANET, that detect transmissions of the second communication network.

15. A mobile ad-hoc network (MANET) for communicating in the presence of a second communication network, the MANET comprising:
a plurality of nodes, wherein each of the nodes is configurable to function according to a first modality in which the node is configured as an operative node and a second modality in which the node is configured as a non-operative node, wherein for each node:
when functioning according to the second modality the node is configured to:
i) obtain frequency channel information associated with the second communication network from detected transmissions of the second communication network, and
ii) transmit the obtained frequency channel information according to a cooperative signaling scheme, and
when functioning according to the first modality the node is configured to:
i) obtain frequency channel information associated with the second communication network from detected transmissions of the second communication network,
ii) receive the obtained frequency channel information transmitted from at least some of the non-operative nodes, and
iii) form a frequency channel map based in part on the received obtained frequency channel information and the frequency channel information obtained by the node.

16. The MANET of claim 15, wherein for each node, when functioning according to the first modality, the node is configured to operate a transceiver of the node based on the frequency channel map.

17. The MANET of claim 16, wherein for each node, when functioning according to the first modality, the node is configured to operate the transceiver of the node to broadcast data on one or more operational frequencies, of one or more frequency channels, indicated by the frequency channel map as being an available operational frequency channel.

18. The MANET of claim 16, wherein the node is configured to broadcast data using a sparse frequency waveform.

19. The MANET of claim 16, wherein for each node, when functioning according to the second modality, the node remains idle while any other node that functions according to the first modality broadcasts data on the one or more operational frequencies indicated by the frequency channel map as being an available operational frequency.

20. The MANET of claim 16, wherein for each node, when functioning according to the first modality, the node is configured to operate the transceiver of the node to terminate a transmission of data on one or more operational frequencies, of one or more frequency channels, indicated by the frequency channel map as being unavailable operational frequencies.

21. The MANET of claim 15, wherein for each node, when functioning according to the first modality, the node is configured to obtain frequency channel information associated with the second communication network by detecting transmissions of the second communication network.

22. The MANET of claim 15, wherein for each node, when functioning according to the second modality, the node is configured to obtain frequency channel information associated with the second communication network by detecting transmissions of the second communication network.

23. The MANET of claim 15, wherein for each node, when functioning according to the second modality, the node is configured to obtain frequency channel information associated with the second communication network by receiving frequency channel information associated with the second communication network from one or more network sensors, separate from the MANET, that detect transmissions of the second communication network.
